(19) United States
(12) Patent Application Publication
(10) Pub. No.: US 2006/0209197 A1
(43) Pub. Date: Sep. 21, 2006

(54) Camera devices

(75) Inventor: Aki Vanhatalo, Hampshire (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/081,399

(22) Filed: Mar. 15, 2005

(51) Int. Cl. H04N 5/262

(52) U.S. Cl. 348/239

(57) ABSTRACT

The present invention provides an electronic camera device (100) arranged to capture one or more scenes to provide one or more corresponding digital images, the device (100) having a first orientation and a second orientation for the capture of the or each digital image, the device comprising a first capture key (A) and a second capture key (B), the first capture key (A) being associated with the capture of the or each image in the first device orientation and the second capture key (B) being associated with the capture of the or each image in the second device orientation, and wherein the device comprises one or more processors arranged to differentiate between the capture keys (A, B) used to capture the or each digital image and to provide the or each image for display in an upright scene orientation in a viewing orientation corresponding to the first device orientation.

### FIELD OF THE INVENTION

The present invention relates camera devices and in particular digital camera technology and devices incorporating digital camera technology. Such devices include, but are not limited to, mobile phones having camera functionality. These mobile phones may have additional functionality.

Embodiments of camera devices within the context of this specification are considered to include devices which are arranged to capture still and/or video images. The devices may be arranged to capture short video clips or videos of a longer duration.

The devices can be used to view the images immediately following capture and/or at a later time. The devices may also be arranged to perform post-capture image processing. The devices can be coupled (using wired or wireless technology) to one or more devices to allow later viewing/processing of the images.

The images are stored on memory media. These may be internal or external to the device or may or may not be removable from the device. The memory media can comprise one or more removable electronic memory cards. The memory media may be optical discs.

For simplicity, the foregoing text will be focussed around digital camera devices. Such devices are preferred embodiments of the invention. However, embodiments of the invention could be applied to optical camera devices which unlike digital camera devices, store images on photographic media rather than in a digital form.

### BACKGROUND TO THE INVENTION

Digital camera and camera phone users can take pictures both in landscape and portrait formats. If users take portrait pictures in one orientation, they need to rotate the device in their hands by 90 degrees to take landscape pictures. Users can use post processing to re-orientate the images to be displayed in the correct orientation when viewed. The same applies for capturing video images.

Basic devices usually have no knowledge of the device orientation during capture time i.e. at the time when an image/picture of a scene is taken. When later viewing the images on the device screen, the device does not know in which orientation the picture was taken. The result is that if the device shows landscape pictures on the correct orientation on the screen, the device will show portrait pictures in a wrong orientation (or vice versa). Images taken in the other orientation are orientated in the same way as user's eyes, but images taken in the other orientation will be shown 90 degrees rotated compared to the user's eyes (see FIG. 1). If the orientation is wrong, the user has to either rotate the device or ask the software to rotate the image.

If the device were aware of its physical orientation when the image is captured, the device could automatically rotate the image into the correct orientation during capture time, or any time before presenting the picture to the user. More complicated devices may have one or more orientation sensors to detect the device orientation at the moment of image capture. However, the inclusion of such sensors and associated circuitry make such devices more expensive.

Camera devices generally have an upright device orientation in which the camera is held in its normal/usual operating position. This is particularly so for cameras which are arranged to capture images in both portrait and landscape formats.

An upright device orientation can directly provide the digital image in an upright scene orientation. A non-upright device orientation would ordinarily directly provide the digital image in the non-upright position. Some intermediate processing would be required to orientate the image into the upright scene orientation.

In the case of a portrait/landscape format camera device, the upright device orientation is generally used to correspond to a landscape format image. An image taken when the camera is rotated into the portrait device orientation would ordinarily directly provide the portrait image for display in a correspondingly rotated landscape orientation (non-upright position). Some intermediate processing would be required to orientate the image into the upright scene orientation in which the portrait image can be viewed in the correct portrait orientation i.e. in which the captured orientation is corrected to provide the image for viewing in the intended orientation.

### SUMMARY OF THE INVENTION

In a first aspect, the present invention provides an electronic camera device arranged to capture one or more scenes to provide one or more corresponding digital images, the device having a first orientation and a second orientation for the capture of the or each digital image, the device comprising a first capture key and a second capture key, the first capture key being associated with the capture of the or each image in the first device orientation and the second capture key being associated with the capture of the or each image in the second device orientation, and wherein the device comprises one or more processors arranged to differentiate between the capture keys used to capture the or each digital image and to provide the or each image for display in an upright scene orientation in a viewing orientation corresponding to the first device orientation.

Camera devices are often rotated prior to capturing a digital image of a scene. The camera according to the present invention can distinguish between images taken in different device orientations based on the capture key used to capture the or each digital image. The camera can therefore consider in which orientation the image was taken and appropriately arrange the image for display in the upright scene orientation in a viewing orientation corresponding to the first device orientation. A user viewing the display does not himself/herself have to rotate the image or display to view in the upright scene orientation.

The viewing orientation corresponds to the first device orientation. Images may be provided on a display which is part of the device or on a display which is separate to the device. In the case that the image is provided on a display which is part of the device, the device needs to be rotated into the first device configuration to view the images in the upright scene orientation. In the latter case, the images are provided for view in same viewing orientation, this viewing orientation corresponding to the capture of images in the first orientation of the device.

An upright scene orientation provides an image in which the top of the displayed digital image corresponds to the top of the scene image. Similarly, the bottom, left and right of the displayed digital image correspond to the bottom, left and right of the scene image. Images are not considered by the camera user to be rotated from their correct captured viewing orientation.

The correct captured viewing orientation is from the perspective of the camera device user, and includes the capturing of scenes which are purposefully taken in, for example, an upside-down orientation. The image will be provided in the correspondingly upside-down orientation, subject to the user using the associated capture key.

Take the example of a user capturing an image of an airplane flying horizontally upside-down using the device in the second device orientation. In this case, the second orientation will provide a portrait format image. According to the present invention, if the user captures the image using the second capture key, the image provided for display will show an upside down airplane flying horizontally captured in portrait format, and not, for example, a landscape image of an airplane heading up into the sky.

The present invention provides a comparatively low cost, simple, and elegant solution to allow images to be displayed in their correct orientation.

The first or second device orientation may be the normal/usual operating position of the device.

The or each processor may be arranged to identify that the second capture key has been used to capture the or each digital image, and to provide the or each digital image captured using the second capture key in the upright scene orientation.

The device may comprise a memory arrangable to store the orientation difference between the first device orientation and the second device orientation, and the device may be arranged to modify the or each digital image captured using the second capture key by the orientation difference between the first device orientation and the second device orientation to provide the or each digital image in the upright scene orientation.

Preferably, the or each processor is arranged to modify the or each captured image using the second capture key by the orientation difference between the first device orientation and the second device orientation to provide the or each digital image in the upright scene orientation.

The or each processor may be arranged to identify that the second capture key has been used to capture the or each digital image and the device may be arranged to rotate the or each captured digital image into the upright scene orientation prior to storing the or each digital image on a memory.

Preferably, the or each processor is arranged identify that the second capture key has been used to capture the or each digital image and the or each processor is arranged to rotate the or each captured digital image into the upright scene orientation prior to storing the or each digital image on a memory.

In a preferred embodiment, the device comprises a memory to store the or each captured digital image, and the device is arranged to store the or each digital image on the memory in the upright scene orientation.

The device may comprise a memory to store the or each captured digital image and the or each processor may be arranged identify that the second capture key has been used to capture the or each digital image and the device may be arranged to rotate the or each captured digital image into the upright scene orientation prior to storing the digital image on the memory.

Preferably, the or each processor is arranged to rotate the or each captured digital image into the upright scene orientation prior to storing the image on the memory.

The or each processor may be arranged to rotate the orientation of the or each image captured using the second capture key by 90/180/270 degrees prior to saving on a memory or displaying on a display.

The or each processor is preferably arranged to rotate the orientation of the or each image captured using the second capture key in an anticlockwise and/or clockwise direction prior to saving on a memory or displaying on a display.

In a preferred embodiment, the device is arranged to provide an orientation indication to the or each captured digital image, derived from the capture key used to capture the image, the orientation indication being useable to display the digital image in the upright scene orientation.

The or each processor may be arranged to provide an orientation indication to the or each captured digital image, derived from the capture key used to capture the image, the orientation indication being useable to display the digital image in the upright scene orientation.

The orientation indication may be usable by the device or another device to display the digital image in the upright scene orientation.

The orientation indication may be added to an existing image protocol e.g. JPEG, MPEG. The orientation indication may be added to an existing image protocol and not change the structure of that protocol. The orientation indication may be a supplemental indicator which is added to an existing structure of an existing image protocol.

The indication may be provided for digital images captured using the first capture key and/or the second capture key. The indication may be provided only for digital images captured using the second capture key.

Preferably, the device comprises camera functionality arranged to capture and process the or each image captured by the device.

The device preferably comprises one or more optical sensors and one or processors arranged to process the images captured with the or each optical sensor.

Preferably, the or each processor arranged to process the images captured with the or each optical sensor are the same processors used to differentiate between the capture keys used to capture the or each digital image and to provide the or each image for display in an upright scene orientation.

The camera functionality may provide a square, rectangular and/or circular digital image. The camera functionality may provide a 4:3 digital image.

Preferably, the first device orientation provides a portrait format image, and the second device orientation provides a landscape format image. The first device orientation may provides a landscape format image, and the second device orientation may provide a portrait format image

Preferably, the first and second capture keys are arranged to control the operation of an electronic camera shutter.

The first capture key may be arranged to provide device user interface navigation.

The first and/or second capture keys may be capacitance responsive to respond to touching without significant depression of the keys.

The first and/or second capture keys are preferably ergonomically and/or intuitively positioned to allow use for capture of images in the first and second device orientations.

Ergonomic positioning allows comfortable use of the capture keys.

Intuitive positioning provides keys on appropriate faces of the device so that a user will readily appreciate that a particular key will perform the desired operation of display of the captured image in the upright scene orientation.

So for example, a capture key on the base for when an image is to be taken with the camera rotated by 180° from the upright orientation, a capture key positioned on a face 90° clockwise to the upright capture key for images to be taken when the camera is rotated 90 anti-clockwise to the upright orientation. This latter example is for a right-handed user. The reverse would be more comfortable and intuitive for a left-handed user. Advantageously, capture keys can be provided on anti-clockwise and clockwise faces so that both left-handed and right-handed users can intuitively and comfortable use the device. The device would then preferably be configurable to be used in either left-handed or right-handed modes (or both).

The device may comprise a front face, a rear face and one or more side faces joining the front and rear faces, and the device may further comprise camera functionality arranged to take one or more digital images of scenes forward of the front/rear face, and wherein one or more first capture keys are positioned on the rear/front face and one or more second capture keys are positioned on one or more of the side faces.

The device may be substantially rectangular having two pairs of substantially parallel opposing sides, one pair of sides being longer than the other shorter pair of sides and the first capture key may be on one of the longer sides and the second capture key may be on a shorter side.

The device may comprise one or more faces, and a capture key may be provided on one or more device faces.

The device may comprise one or more displays for the display of the or each captured digital image.

The device may comprise one or more memories to store the or each captured image.

The device may comprise one or more memories to store the or each captured image, and the memory may be removable from the device. The device may comprise one or more permanent memories to permanently store the or each captured image. The device may comprise one or more temporary memories to temporarily store the or each captured image. The device may comprise one or more re-writeable memories to store the or each captured image.

The device may comprise wireless connectivity functionality. The device may comprise wireless connectivity functionality and the wireless connectivity functionality may be arranged to transmit the or each image to another device.

The device may comprise mobile phone functionality.

The first and second device orientations may be in different orientations in a vertical plane and/or in the line of gravity. The first and second device orientations may be in different orientations in a horizontal plane. The first and second device orientations may be at 90/180/270 degrees to one another.

The first and second device orientations may be in parallel planes or perpendicular planes. The first and second orientations may be in different planes.

In a second aspect, the present invention provides a digital image comprising an orientation indication derived from a capture key used to capture the digital image, the orientation indication being useable to display the digital image in an upright scene orientation.

In a third aspect, the present invention provides a memory with a digital image with an orientation indication derived from a capture key used to capture the digital image, the orientation indication being useable to display the digital image in an upright scene orientation.

In a fourth aspect, the present invention provides a signal comprising a digital image with an orientation indication derived from a capture key used to capture the digital image, the orientation indication being useable to display the digital image in an upright scene orientation.

In a fifth aspect, the present invention provides a camera module arrangable to capture one or more scenes to provide one or more digital images to a device having a first orientation and a second orientation, and comprising one or more processors arrangable to differentiate between a first and a second capture key input, the first capture key input associated with capture of an image in the first device orientation and the second capture key input associated with the capture of an image in the second device orientation, and wherein the or each processors are arrangable to provide the or each image for display in an upright scene orientation in a viewing orientation corresponding to the first device orientation.

In a sixth aspect, the present invention provides a camera device arranged to capture one or more scenes to provide one or more corresponding images, the device having a first orientation and a second orientation for the capture of the or each image, the device comprising a first capture key and a second capture key, the first capture key being associated with the capture of the or each image in the first device orientation and the second capture key being associated with the capture of the or each image in the second device orientation, and wherein the device comprises one or more sensors arranged to differentiate between the capture keys used to capture the or each image and to provide the or each image for storage on a media in an upright scene orientation in a viewing orientation corresponding to the first device orientation.

The present invention also provides preferred embodiments for the second, third, fourth, fifth and/or sixth aspects of the invention in accordance with appropriately modified preferred embodiments of the first aspect of the invention. The present invention provides a combination of one or more aspects/preferred embodiments of the present invention whether or not it is specifically mentioned or claimed.

### DESCRIPTION OF FIGURES

Specific embodiments of the invention will now be described, by way of example only, with reference to the following figures in which:

FIG. 1 illustrates the images captured by a camera device in landscape and portrait device orientations which is not able to detect the different orientations;

FIG. 2 illustrates a schematic internal structure of a mobile telecommunications device having camera functionality according to the present invention;

FIG. 3 illustrates a mobile telecommunications device according to the present invention; and

FIG. 4 provides a flowchart showing the operations performed by a device according to the present invention.

### DESCRIPTION OF SPECIFIC EMBODIMENTS

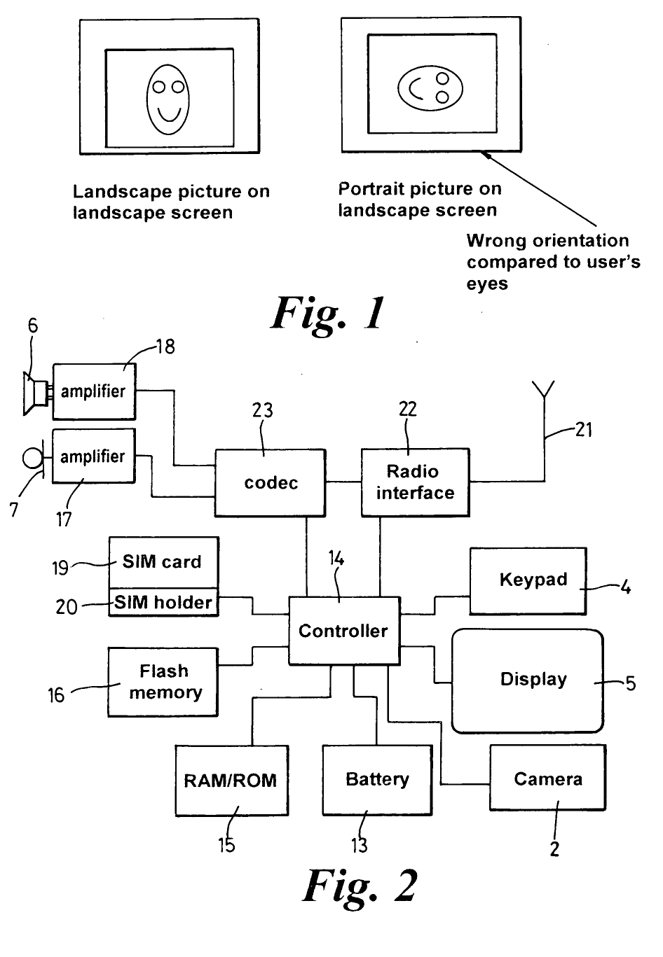

FIG. 1 has been used to describe the Background to the Invention.

FIG. 2 provides a schematic of the general structure of a mobile phone 100 incorporating a camera according to the present invention. The phone 100 is arranged to operate in a GSM network but may be arranged to operate in any cellular network.

The phone 100 is driven by a removable batter pack 13. Signal processing is carried out under the control of a digital microcontroller 14, which has an associated RAM/ROM 15 and a flash memory 16. Electric analogue signals are produced by microphone 7 and amplified by pre-amplifier 17. Similarly, analogue audio signals are fed to earpiece 6 through amplifier 18. The microcontroller 14 receives instructions signals from keypad 4 and controls the operation of the display 5 and camera 2. The controller 14 also interface with a SIM card 19 held in a SIM card holder 20. The nature of the SIM card/holder are well known in the art and not described in any further detail.

Radio signals are transmitted and received by means of an antenna 21 connected through an RF stage 22 to a codec 23 configured to process signals under the control of the micro-controller 14. Thus, in use, for speech, the codec 23 receives analogue signals from the microphone amplifier 17, digitises them into a suitable form for transmission and feeds them to the RF stage 22 for transmission through antenna element 21 to the public land mobile network (PLMN). Similarly, received signals are fed to codec 23 so as to produce analogue signals to amplifier 18 and earpiece 6.

As previously mentioned, the controller 14 also controls the operation of the camera 2. This includes operation of the electronic shutters of the camera optical sensor. The controller 14 also receives the digital camera images and processes them for display on the display 5. The controller 14 may also arrange for the image to be stored in the flash memory 16 or be transmitted over the GSM network via the radio interface 22.

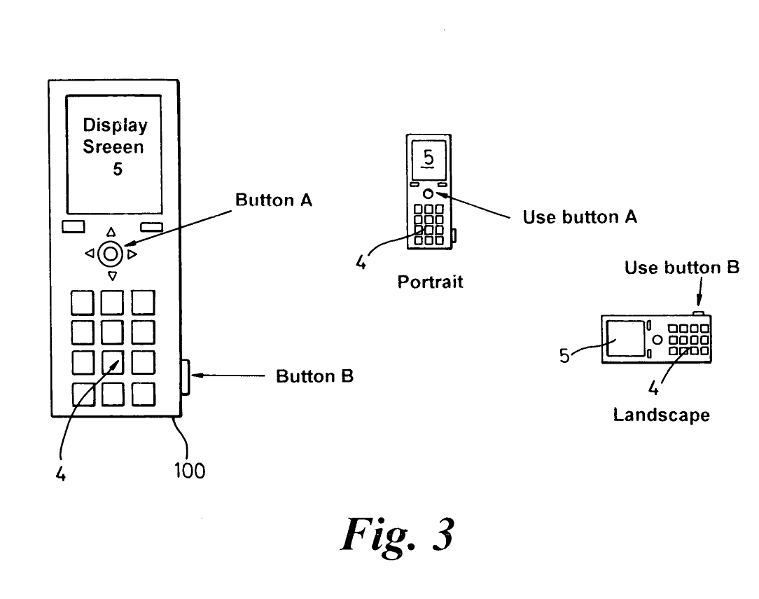

The camera phone 100 of FIG. 3 is arranged to take both still and video images. The camera lens is not shown but is on the reverse of the camera phone 100. The display 5 is used to view images captured by the phone 100. The phone 100 has a keypad 4 comprising two capture keys A and B. Each capture key triggers the taking of one or more digital images. In the case the camera 100 is operating in still image mode, the capture keys A, B trigger the capture taking of the still image. In the case the phone 100 is operating in video mode, the capture keys A, B are used to start and stop the recording. The phone may be arranged to stop video recording after a predetermined time, in which case the capture keys will trigger the start and not the end of video capture.

The phone 100 is able to take portrait and landscape format images. The phone 100 is arranged to take portrait images when the phone is held in an upright orientation, and landscape images when it is held in a perpendicular orientation to the upright orientation.

The capture key A also provides navigation functions. Thus, it can accept 5 inputs; up/down/left/right and depression. The capture key 5 is arranged such that depression of the key 5 triggers image recording. Capture key 5 is ergonomically positioned toward the middle front face of the phone 100.

Capture key B detect depression to activate the capturing of images. It is ergonomically positioned on one side towards the base of the phone 5. In the configuration shown, capture key B is positioned such that a right-handed user can rotate the phone in a 90 degrees anti-clockwise direction and take a landscape image with the capture key B comfortably operable by the right hand.

A user can use the phone 100 to capture images when the phone 100 is held in the upright device orientation, or in the 90 degrees anticlockwise orientation.

In the upright orientation, the user can depress capture key A and can frame and provide a portrait format image. This is provided for display on the display screen 5. If the user views the screen 5 when the phone 100 is held in the upright orientation, the image is shown to be provided in the correctly oriented portrait format. This is the upright scene orientation.

In the case that the user uses capture key B in the upright orientation, the image is also captured. But when the user views the captured image on the phone 100 held in the upright orientation, the captured image is provided on the display in a 90 degrees anti-clockwise landscape orientation.

Images can also be captured when the device is held in the 90 degrees anticlockwise orientation. This orientation is particularly suited for landscape images. Again, the user can take an image by pressing either capture key A or B.

In the case that capture key B is used, when the device is subsequently held in the upright orientation, the image is shown to be provided for display in the correctly oriented landscape format. This is the upright scene orientation.

If capture key A were used, when the camera 100 is held in the upright position, when the camera 100 is returned to the upright orientation, the image will be in a 90 degrees clockwise portrait orientation.

The phone may be arranged to store the images in a rotated form. The phone may be arranged to provide an indication in the captured digital image of which images need to be rotated and which do not.

The images may be stored on the phone and/or provided to a remote device by wired or wireless technology. Wireless technology may include Bluetooth™, Wireless Local Area Network (WLAN) and/or cellular technology or any variation thereof.

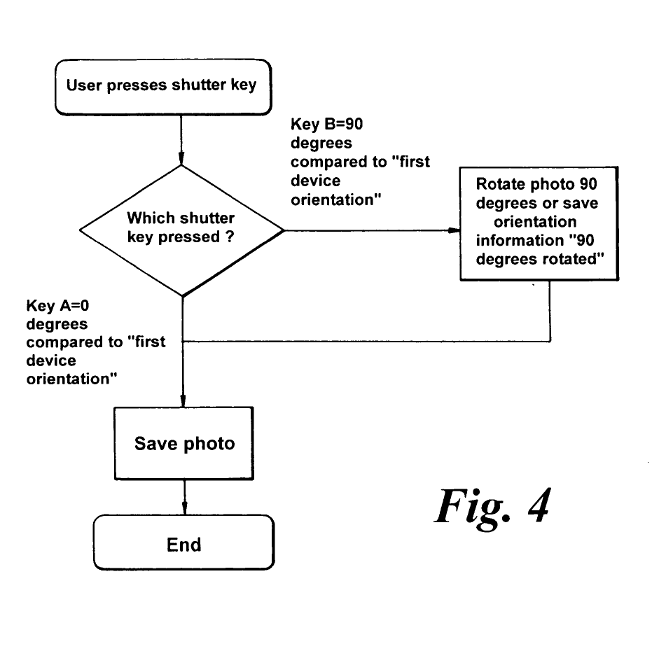

FIG. 4 illustrates a flowchart summarising the operation of a camera device in the case when the image is stored for display in a correctly rotated format. The camera device senses which shutter key was used to take the image. If the camera is rotated by for example, 90° clockwise, when the image is taken, then depending on the capture key used, the image is rotated by 90° anticlockwise prior to storage. In the embodiment of FIG. 3, the first device orientation of FIG. 4 would be the upright device orientation.

It will be appreciated that various modifications can be made to the aforementioned embodiments without departing from the scope of the invention.

For example, in the embodiment of FIG. 3, the camera sensor may provide a landscape image in the upright device (first) orientation and a portrait image in the second device orientation. Thus, capture key A can provide a landscape image and capture key B a portrait image.

Capture keys can be positioned on one or more of the faces of the phone and the phone may be configured to provide the image for display based on differentiating between the orientation of the capture keys. For example, in the case that a capture key is on the base of a phone, the image may be rotated by 180 degrees when the base capture key is used to capture an image.

The upright scene oriented images may be provided in real time, i.e. as you are taking them. This function may be facilitated by the phone being arrangable to know which orientation it is in and/or which capture key is going to be (or can be) used to capture images.

The camera device may be arrangable such that one or more capture keys can be deactivated in a particular orientation. The orientation of the images into the upright scene orientation images can be provided by optical methods.

The invention is applicable to cameras per se, regardless of whether they are digital or purely optical. In the case of optical camera devices, optics may be used to orientate the image prior to storage on a memory media, such as a photographic film.

1. An electronic camera device (100) arranged to capture one or more scenes to provide one or more corresponding digital images, the device (100) having a first orientation and a second orientation for the capture of the or each digital image,
the device comprising a first capture key (A) and a second capture key (B), the first capture key (A) being associated with the capture of the or each image in the first device orientation and the second capture key (B) being associated with the capture of the or each image in the second device orientation,
and wherein the device comprises one or more processors arranged to differentiate between the capture keys (A, B) used to capture the or each digital image and to provide the or each image for display in an upright scene orientation in a viewing orientation corresponding to the first device orientation.

2. A device according to claim 1 wherein the first device orientation is the normal/usual operating position of the device.

3. A device according to claim 1, wherein the or each processor is arranged to identify that the second capture key (B) has been used to capture the or each digital image, and to provide the or each digital image captured using the second capture key (B) in the upright scene orientation.

4. A device according to claim 1, wherein the device comprises a memory arrangable to store the orientation difference between the first device orientation and the second device orientation and wherein the device is arranged to modify the or each digital image captured using the second capture key (B) by the orientation difference between the first device orientation and the second device orientation to provide the or each digital image in the upright scene orientation.

5. A device according to claim 1, wherein the device comprises a memory arrangable to store the orientation difference between the first device orientation and the second device orientation and wherein the or each processor is arranged to modify the or each captured image using the second capture key (B) by the orientation difference between the first device orientation and the second device orientation to provide the or each digital image in the upright scene orientation.

6. A device according to claim 1, wherein the or each processor is arranged identify that the second capture key (B) has been used to capture the or each digital image and the device is arranged to rotate the or each captured digital image into the upright scene orientation prior to storing the or each digital image on a memory.

7. A device according to claim 1, wherein the or each processor is arranged identify that the second capture key (B) has been used to capture the or each digital image and the or each processor is arranged to rotate the or each captured digital image into the upright scene orientation prior to storing the or each digital image on a memory.

8. A device according to claim 1, wherein the device comprises a memory to store the or each captured digital image, and the device is arranged to store the or each digital image on the memory in the upright scene orientation.

9. A device according to claim 1, wherein the device comprises a memory to store the or each captured digital image and the or each processor is arranged identify that the second capture key (B) has been used to capture the or each digital image and the device is arranged to rotate the or each captured digital image into the upright scene orientation prior to storing the digital image on the memory.

10. A device according to claim 1, wherein the device comprises a memory to store the or each captured digital image and the or each processor is arranged identify that the second capture key (B) has been used to capture the or each digital image and the or each processor is arranged to rotate the or each captured digital image into the upright scene orientation prior to storing the image on the memory.

11. An electronic device according to claim 1, wherein the or each processor is arranged to rotate the orientation of the or each image captured using the second capture key by 90 degrees prior to saving on a memory or displaying on a display.

12. An electronic device according to claim 1, wherein the or each processor is arranged to rotate the orientation of the or each image captured using the second capture key by 180 degrees prior to saving on a memory or displaying on a display.

13. An electronic device according to claim 1, wherein the or each processor is arranged to rotate the orientation of the or each image captured using the second capture key by 270 degrees prior to saving on a memory or displaying on a display.

14. An electronic device according to claim 1, wherein the or each processor is arranged to rotate the orientation of the or each image captured using the second capture key in an anticlockwise direction prior to saving on a memory or displaying on a display.

15. An electronic device according to claim 1, wherein the or each processor is arranged to rotate the orientation of the or each image captured using the second capture key in an clockwise direction prior to saving on a memory or displaying on a display.

16. A device according to claim 1, wherein the device is arranged to provide an orientation indication to the or each captured digital image, derived from the capture key used to capture the image, the orientation indication being useable to display the digital image in the upright scene orientation.

17. A device according to claim 1, wherein the or each processor is arranged to provide an orientation indication to the or each captured digital image, derived from the capture key used to capture the image, the orientation indication being useable to display the digital image in the upright scene orientation.

18. A device according to claim 16, wherein the orientation indication is usable by another device to display the digital image in the upright scene orientation.

19. A device according to claim 16, wherein the orientation indication is added to existing image protocol.

20. A device according to claim 16, wherein the orientation indication is added to existing image protocol and does not change the structure of that protocol.

21. A device according to claim 16, wherein the orientation indication is a supplemental indicator which is added to an existing structure of an existing image protocol.

22. A device according to claim 16, wherein the indication is provided for digital images captured using the first capture key (A).

23. A device according to claim 16, wherein the indication is provided for digital images captured using the second capture key (B).

24. A device according to claim 1, wherein the device comprises one or more optical sensors and one or processors arranged to process the images captured with the or each optical sensor.

25. A device according to claim 1, wherein the first device orientation provides a portrait format image, and the second device orientation provides a landscape format image.

26. A device according to claim 1, wherein the first and second capture keys are arranged to control the operation of an electronic camera shutter.

27. A device according to claim 1, wherein the first capture key (A) is arranged to provide device user interface navigation.

28. A device according to claim 1, wherein the first and/or second capture keys are ergonomically and/or intuitively positioned to allow use for capture of images in the first and second device orientations.

29. A device according to claim 1, wherein the device comprises a front face, a rear face and one or more side faces joining the front and rear faces, the device comprising camera functionality arranged to take one or more digital images of scenes forward of the rear/front face, and wherein one or more first capture keys are positioned on the front/rear face and one or more second capture keys are positioned on one or more of the side faces.

30. A device according to claim 1, wherein the device is substantially rectangular having two pairs of substantially parallel opposing sides, one pair of sides being longer than the other shorter pair of sides and wherein the first capture key is on one of the longer sides and the second capture key is on a shorter side.

31. A device according to claim 1, wherein the device comprises one or more faces, and a capture key is provided on one or more device faces.

32. A device according to claim 1, wherein the device comprises one or more displays for the display of the or each captured digital image.

33. A device according to claim 1, wherein the device comprises one or more memories to store the or each captured image.

34. A device according to claim 1, wherein the device comprises wireless connectivity functionality and wherein the wireless connectivity functionality is arranged to transmit the or each image to another device.

35. A device according to claim 1, wherein the device comprises mobile phone functionality.

36. An electronic device according to claim 1, wherein the first and second device orientations are different orientations in a vertical plane.

37. An electronic device according to claim 1, wherein the first and second device orientations are different orientations in the line of gravity.

38. An electronic device according to claim 1, wherein the first and second device orientations are different orientations in a horizontal plane.

39. An electronic device according to claim 1, wherein the first and second device orientations are in parallel planes.

40. An electronic device according to claim 1, wherein the first and second device orientations are in perpendicular planes.

41. An electronic device according to claim 1, wherein the first and second orientations are in different planes.

42. A digital image comprising an orientation indication derived from a capture key used to capture the digital image, the orientation indication being useable to display the digital image in an upright scene orientation.

43. A memory comprising a digital image with an orientation indication derived from a capture key used to capture the digital image, the orientation indication being useable to display the digital image in an upright scene orientation.

44. A signal comprising a digital image with an orientation indication derived from a capture key used to capture the digital image, the orientation indication being useable to display the digital image in an upright scene orientation.

45. A camera module arrangable to capture one or more scenes to provide one or more digital images to a device having a first orientation and a second orientation, and comprising one or more processors arrangable to differentiate between a first and a second capture key input, the first capture key input associated with capture of an image in the first device orientation and the second capture key input associated with the capture of an image in the second device orientation, and wherein the or each processors are arrangable to provide the or each image for display in an upright scene orientation in a viewing orientation corresponding to the first device orientation.

46. A camera device arranged to capture one or more scenes to provide one or more corresponding images, the device having a first orientation and a second orientation for the capture of the or each image, the device comprising a first capture key and a second capture key, the first capture key being associated with the capture of the or each image in the first device orientation and the second capture key being associated with the capture of the or each image in the second device orientation, and wherein the device comprises one or more sensors arranged to differentiate between the capture keys used to capture the or each image and to provide the or each image for storage on a media in an upright scene orientation in a viewing orientation corresponding to the first device orientation.
